(19) United States
(12) Patent Application Publication
(10) Pub. No.: US 2026/0361918 A1
(43) Pub. Date: Nov. 12, 2026

(54) SIGN PREDICTION OF TRANSFORM COEFFICIENTS

(71) Applicant: InterDigital CE Patent Holdings, SAS, Paris (FR)

(72) Inventors: Ya CHEN, Rennes (FR); Edouard FRANCOIS, Bourg des Comptes (FR); Franck GALPIN, Thorigne-Fouillard (FR); Karam NASER, Mouazé (FR); Frank BOSSEN, Toronto (CA)

(21) Appl. No.: 19/475,339

(22) PCT Filed: Apr. 16, 2024
(86) PCT No.: PCT/EP2024/060276

§ 371 Date: Oct. 14, 2025

(30) Foreign Application Priority Data
Apr. 21, 2023 (EP) 23315094.5

(51) Int. Cl. H04N 19/61; H04N 19/136; H04N 19/176; H04N 19/18

(52) U.S. Cl. CPC H04N 19/61; H04N 19/136; H04N 19/176; H04N 19/18

(57) ABSTRACT

In order to improve or simplify sign prediction of transform coefficients, several aspects are proposed. For example, the signs to be predicted can be selected by sorting transform coefficients with the same qIdx value based on a weighted qIdx value. Alternatively, instead of sorting based on qIdx, we can place the significant coefficients with the absolute level value over a threshold at the beginning to perform the sign prediction in a transform block. In another example, the predicted residual can be generated with more complicated models than simple linear prediction. CABAC context derivation can also be modified for predicted signs. In addition, the maximum number of predicted signs can be adapted to the block size, maximum sign prediction area, energy, transform type, QP, block prediction mode of a TB, or other parameters.

### TECHNICAL FIELD

The present embodiments generally relate to a method and an apparatus for prediction residual sign prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video decoding is presented, comprising: determining a limit on the number of signs to be predicted for a block based on coding conditions and parameters; obtaining a signal indicating whether a sign of a transform coefficient matches a predicted sign of said transform coefficient; obtaining said predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit; obtaining said sign for said transform coefficient, based on said predicted sign and said signal; inverse transforming a block of transform coefficients corresponding to said block, said block of transform coefficients including said transform coefficient; and decoding said block based on a prediction block corresponding to said block and said block of transform coefficients.

According to another embodiment, a method of video encoding is presented, comprising: determining a limit on the number of signs to be predicted for a block based on coding conditions and parameters; obtaining a sign of a transform coefficient; obtaining a predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit; obtaining a signal to indicate whether said predicted sign matches said sign of said transform coefficient; and encoding said signal.

According to another embodiment, an apparatus is presented, comprising at least one memory and one or more processors, wherein said one or more processors are configured to: determine a limit on the number of signs to be predicted for a block based on coding conditions and parameters; obtain a signal indicating whether a sign of a transform coefficient matches a predicted sign of said transform coefficient; obtain said predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit; obtain said sign for said transform coefficient, based on said predicted sign and said signal; inverse transform a block of transform coefficients corresponding to said block, said block of transform coefficients including said transform coefficient; and decode said block based on a prediction block corresponding to said block and said block of transform coefficients.

According to another embodiment, an apparatus is presented, comprising at least one memory and one or more processors, wherein said one or more processors are configured to: determine a limit on the number of signs to be predicted for a block based on coding conditions and parameters; obtain a sign of a transform coefficient; obtain a predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit; obtain a signal to indicate whether said predicted sign matches said sign of said transform coefficient; and encode said signal.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates neighboring samples are used to obtain predicted residuals.

FIG. 5 illustrates DQ (Dependent Quantization).

FIG. 6 illustrates a method of sign prediction at the encoder, according to an embodiment.

FIG. 7 illustrates a method of sign prediction at the decoder, according to an embodiment.

FIG. 8 illustrates a method of adapting the maximum number of predicted signs based on the block size, according to an embodiment.

### DETAILED DESCRIPTION

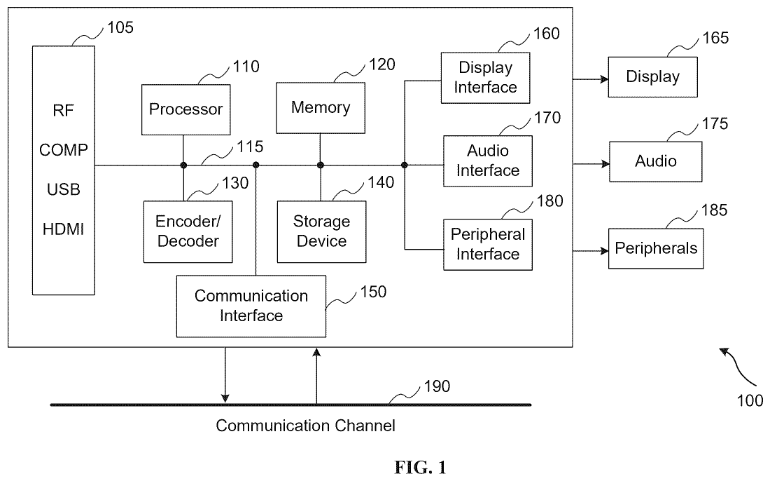

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

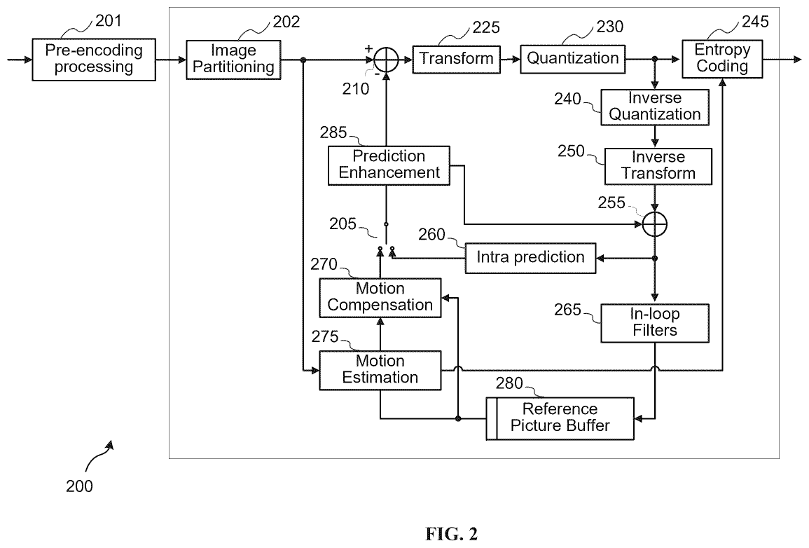

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. After prediction, prediction enhancement (285) is applied to the prediction block. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

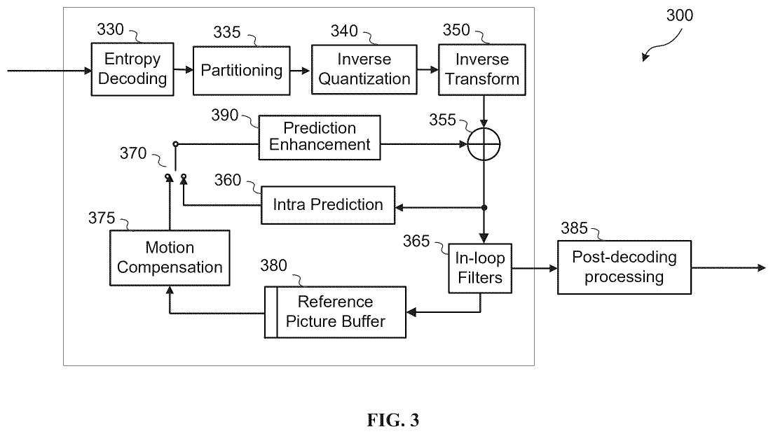

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). After prediction, prediction enhancement (390) is applied to the prediction block. In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

### Sign Prediction of Transform Coefficients in Recent Video Codecs

In the residual coding process of the Exploratory Coding Model (ECM), coefficient sign prediction is a coding tool which is used to compress some of signs of transform coefficients using a system of prediction. A sign that has been predicted is no longer EP (Equal Probability) coded (entropy coded in the bypass mode) in the bitstream, but is replaced by a “residual” (signaled using an associated CABAC context) which indicates if the sign prediction was correct or not.

Examples of such methods are described in Y.-W. Chen, et al., “Description of SDR, HDR and 360° video coding technology proposal by Qualcomm and Technicolor-low and high complexity versions”, JVET-J0021, April 2018, San Diego, USA, and in A. Alshin, et al., “Residual Coefficient Sign Prediction”, JVET-D0031, October 2016, Chengdu, China.

Sign prediction methods operate to perform multiple inverse transforms on the transform coefficients of a coding block. For each inverse transform, the sign of a non-zero transform coefficient is set to either negative or positive. The sign combination which minimizes a cost function is selected as the sign predictor to predict the signs of the transform coefficients of the current block. For one example to illustrate this idea, assuming the current block contains two non-zero coefficients, there are four possible sign combinations, namely, (+, +), (+,−), (−, +) and (−,−). For all four combinations, the cost function is calculated and the combination with the minimum cost is selected as a sign predictor. The cost function in an example is calculated as a discontinuity measurement of the samples sitting on the boundary between the current block and its causal neighbors. To derive the best sign prediction hypothesis among all possible combinations, a cost function needs to be defined. In the ECM, the cost function is defined as discontinuity measure across block boundary. It is measured for all hypotheses, and the one with the smallest cost is selected as a predictor for coefficient signs. The predicted value of the current sign is taken from this hypothesis. If the prediction matches the true value of the sign, a “0” is sent as the sign residue, otherwise a “1” is sent. Both encoder and decoder need to generate the reconstructed samples (also known as hypothesis) at the top and left borders of the TB (Transform Block) based on different sign combinations of the selected coefficients.

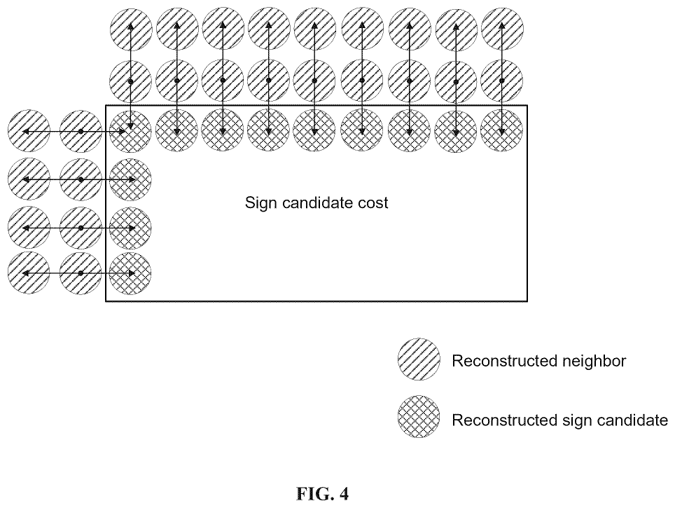

As shown in FIG. 4, for each prediction pixel P_{0,y} at the first left column of the current block, a simple linear prediction using the two reconstructed pixels to the left is performed to get its predicted residual Resi_{0,y}=(2R_{-1,y}−R_{-2,y}−P_{0,y}). The absolute difference between this predicted residual and the residual hypothesis r_{0,y} is added to the cost of the hypothesis.

Similar processing occurs for pixels in the top row of the current block, summing the absolute differences of each predicted residual Resi_{x,0}=(2R_{x,-1}−R_{x,-2}−P_{x,0}) and the residual hypothesis r_{x,0}.

The cost function can be mathematically modelled by the following equation:

$$cost = {\sum }_{x = 0}^{w} \vert ( - {R}_{x , - 2} + 2 {R}_{x , - 1} - {P}_{x , 0} ) - {r}_{x , 0} \vert + {\sum }_{y = 0}^{h} \vert ( - {R}_{- 2 , y} + 2 {R}_{- 1 , y} - {P}_{0 , y} ) - {r}_{0 , y} \vert \qquad ( 1 )$$

where P is the prediction signal of the current block, R is the reconstructed neighbors, and r is the residual hypothesis. The term (−R₋₂+2R₋₁−P₀) can be calculated only once per block and only residual hypothesis is subtracted.

### Sorting Based Sign Selection

To restrict the complexity, there is a limit on the number of signs to be predicted for a TB. In ECM-2.0, the maximum number of signs (maxNumPredSigns) to be predicted is signaled to the decoder through SPS (Sequence Parameter Set). The allowable value of maxNumPredSigns is 0 to 8, inclusive. In CTC (Common Test Conditions), the number of signs to be predicted (NumSignPred) has been set to 8, which is also the value assigned to maxNumPredSigns. Only signs of the top-left 4×4 block of a TB are predicted. The rest of the signs are EP coded. If the number of signs of the top-left 4×4 block of a TB is larger than the maximum limit, first maxNumPredSigns signs (in raster scan order) are predicted.

However, the raster scan order may not be optimal for all TBs. Usually, signs of large transform coefficient are relatively easy to predict since the impact of sign error of large transform coefficients on the reconstructed block are relatively higher. Based on this observation, some sorting based approaches are proposed.

Sorting Based on the Absolute Values of the qIdx

JVET-X0120 (see an article by Yan Ye et al., “AHG12: On sign prediction”, JVET-X0120, 24^{th} JVET meeting, teleconference, October 2021) and JVET-Y0141 (see an article by Jie Chen et al., “EE2-4.3 related: More combined test results for sign prediction”, 25^{th} JVET meeting, teleconference, January 2022) proposed to adaptively select the signs to be predicted based on the absolute value of qIdx (qIdx is the transform coefficient level after compensating the impact of the multiple quantizers in DQ).

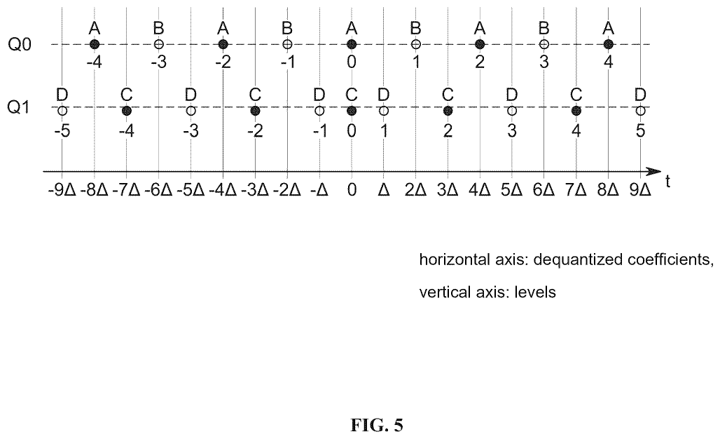

Since ECM-2.0 (also in VVC), the coefficient levels do not accurately reflect the magnitude of transform coefficients due to the use of two quantizers. For same level values, the dequantized transform coefficient may be different because of two quantizers used in DQ (Q0 and Q1 shown in FIG. 5). Assume the following two cases,
Case 1: level=2, quantizer Q0, the dequantized transform coefficient=4Δₖ
Case 2: level=2, quantizer Q1, the dequantized transform coefficient=3Δₖ

In the above two cases, levels are equal to 2 for both cases, however, the dequantized transform coefficient of case 1 (which is 4Δₖ) is larger than case 2 (which is 3Δₖ). Based on this observation, sorting is performed based on the qIdx value (dequantized transform coefficient=qIdx×Δₖ). The qIdx of the level depends on the DQ (Dependent Quantization) state and can be computed as follow:

qIdx=(abs(level)<<1)−(state & 1) (2)

In the proposed method, after decoding the absolute value of the levels, the transform coefficients in the TB are sorted based on the qIdx values. The transform coefficient which has the highest value of qIdx is placed at the beginning of the sorted TB. The first maxNumPredSigns signs in the sorted TB are predicted and the rest of the signs are EP coded. This proposed method was adopted in ECM-4.0.

### Sorting Based on the Energy Impact on the Reconstructed Border Samples

JVET-X0150 (see an article by Xiaoyu Xiu et al. “AHG12: Enhanced sign prediction”, JVET-X0150, 24^{th} JVET meeting, teleconference, October 2021) proposed to select the signs to be predicted, based on their impacts on the quality of the reconstructed border samples of one TB. Specifically, to select the transform coefficients to perform the sign prediction, the following cost function is applied which measures the energy caused by one transform coefficient on the reconstructed border samples:

$$cost = \vert {C}_{i , j} \vert \cdot {\sum }_{k = 0}^{N - 1} \vert {T}_{i , j} ( k ) \vert \qquad ( 3 )$$

where C_{i,j} represents the transform coefficient level at coordinate (i, j) in the TB, and T_{i,j} represents the L-shaped template that corresponds to the transform coefficient, which consists of N reconstructed samples at the top and left border of the TB. Based on the above cost function, the encoder/decoder will select the signs of the coefficients with the maxNumPredSigns largest costs to be predicted.

### Adaptive Sign Prediction Area Setting

In ECM-2.0, only signs of the top-left 4×4 block of a TB are predicted. JVET-X0120 proposed to extend sign prediction area of a TB to maximum 32×32 block. Specifically, in the proposed method, signs of top-left M×N block are predicted. The values of M and N are computed as follows:

M=min(width,32)

N=min(height,32) (4)
where width and height are the width and height of the transform block.

On top of the proposed method from JVET-X0120, JVET-Y0141 proposed that the maximum area for sign prediction is not always set to 32×32. Rather, the encoder sets the maximum area based on the configuration, the sequence class and quantization parameter (QP), and signals the area in SPS. This proposed method was adopted in ECM-4.0.

### Hypothesis Generation

With these n (n is up to maxNumPredSigns) selected transform coefficients, 2ⁿ simplified border reconstructions are performed as described below, one reconstruction per unique combination of signs for the n coefficients.

Only the leftmost and topmost pixels of the block are recreated by adding the results from the inverse transformation to the block prediction. Additionally, to avoid conducting multiple inverse transforms, the existing sign prediction in the ECM-2.0 applies one template-based hypothesis generation scheme, where each template is a set of reconstructed border samples of one TB. The templates are pre-calculated at both encoder and decoder, based on the inverse transform of some unit coefficient matrices, each of which is generated by setting one specific coefficient in the matrix to one while all the others are kept as zeros. In this way, when predicting n signs in a block, only n+1 inverse transform operations are performed:
1. A single inverse transform operating on the dequantized transform coefficients, where the values of all signs being predicted are set positive. Once added to the prediction of the current block, this corresponds to the border reconstruction for the first hypothesis.
2. For each of the n coefficients having their signs predicted, an inverse transform operation is performed on an otherwise empty block containing the corresponding dequantized (and positive) coefficient as its only non-null element. The leftmost and topmost border values are saved in what is termed an L-shaped template T for use during later reconstructions.

Border reconstruction for a later hypothesis starts by taking an appropriate saved reconstruction of a previous hypothesis which only needs a single predicted sign to be changed from positive to negative in order to construct the desired current hypothesis. This change of sign is then approximated by the doubling and subtraction from the hypothesis border of the template corresponding to the sign being predicted. The border reconstruction, after costing, is then saved if it is known to be reused for constructing later hypotheses. Note that these approximations are used only during the process of sign prediction, not during final reconstruction.

TABLE 1
Table showing save/restore and template application
for n = 3 (3 signs, 8 entries)

| Template Name | How to Create |
|---|---|
| T001 | inverse transform single positive 1^{st} coefficient |
| T010 | inverse transform single positive 2^{nd} coefficient |
| T100 | inverse transform single positive 3^{rd} coefficient |

| Hypothesis | How to Create | Store for later reuse as |
|---|---|---|
| H000 | inverse transform all coefficients, | H000 |
| | add to prediction | |
| H001 | H000 - 2*T001 | |
| H010 | H000 - 2*T010 | H010 |
| H011 | H010 - 2*T001 | |
| H100 | H000 - 2*T100 | H100 |
| H101 | H100 - 2*T001 | |
| H110 | H100 - 2*T010 | H110 |
| H111 | H110 - 2*T001 | |

### Signaling, Parsing and Reconstruction of the Sign

Eight CABAC contexts are used when signaling a particular sign prediction residue. The CABAC context to use is determined by whether or not the dequantized coefficient in the raster order is luma/chroma, intra/inter, and lower/higher than a threshold (i.e., threshold is 2).

The decoder, as part of its parsing process, parses transform coefficients, signs for some transform coefficients and sign residues for some other transform coefficients. The signs and sign residues are parsed at the end of the TU, and at that time the decoder knows the absolute values of all coefficients. The knowledge of a “correct” or “incorrect” prediction is simply stored as part of the TU data of the block being parsed. The real sign of its associated coefficient is not known at this point.

Later, during reconstruction, the decoder performs operations similar to the encoder as described above. First, sorting based sign selection is performed. Based on the absolute values of the qIdx, the coefficient which has highest value of qIdx is placed at the beginning of the sorted TB. The stored CABAC coded “residue” signs are applied on those first maxNumPredSigns coefficients in the sorted TB. Then, the real sign to apply to a coefficient that has had its sign predicted is determined by an exclusive- or operation on:
1. The predicted value of the sign.
2. The “correct” or “incorrect” data stored in the TU during bitstream parsing.

### Sign Prediction Applied to LFNST Blocks

In ECM-2.0, the sign prediction is only enabled for the TBs where only primary transforms, including DCT-2 and MTS transform kernels, are applied. For the TBs that apply low-frequency non-separable transform (LFNST), the sign prediction is always skipped.

JVET-X0150 and JVET-Y0141 proposed to apply sign prediction to LFNST blocks. Additionally, to achieve a better gain/complexity trade-off, a maximum of 4 (i.e., M=4) coefficients are allowed to be predicted for one LFNST TB.

The present document aims to improve or simplify coefficient sign prediction. In this document, it is proposed to modify several aspects, including:
1) signs selection:
   a. sorting of coefficients could further be done based on a weighted qIdx value (qIdx is the transform coefficient level after compensating the impact of the multiple quantizers in DQ);
   b. instead of sorting, placing the significant coefficients with the absolute level value over a pre-defined threshold Th (e.g., 1) at the beginning to do the sign prediction in a TB;
2) generate the predicted residual with more complicated models than a simple linear prediction;
3) improve the CABAC context derivation for predicted signs;
4) adaptive maximum number of predicted signs setting based on the block size, maximum sign prediction area, energy, transform type, QP, and/or the block prediction mode of a TB, or other parameters;
5) coding/decoding scanning order, coefficient value range, clipping, chroma scaling if LMCS is used.

### Signs Selection

In the current ECM-8.0, the signs to be predicted are selected based on the absolute value of qIdx (qIdx is the transform coefficient level after compensating the impact of the multiple quantizers in DQ). However, if multiple transform coefficients have the same absolute qIdx value, they may not contribute equally to the reconstructed border samples within the L-shaped template. Thus, in one embodiment, we propose that sorting of coefficients with the same qIdx value could further be done based on a weighted qIdx value, where the weight reflects the energy impact of a coefficient to the samples in the L-shaped template. For example, the weight w could be the sum of absolute reconstructed samples in the L-shaped template corresponding to the coefficient:

$$w = {\sum }_{k = 0}^{N - 1} \vert {T}_{i , j} ( k ) \vert \qquad ( 5 )$$

The weight w could also be measured in other alternative methods, such as the Euclidean distance between the coordinate (i, j) of the transform coefficient to the top-left position of a TB (0,0), or the diagonal scanning order index of the transform coefficient in a TB (scanIdx), and so on.

In one variant of this embodiment, sorting could be done based on weighted qIdx value for all transform coefficients inside the allowed sign prediction area of a TB, and the cost function can be computed as follow:

cost=|qIdx_{i,j}|·w (6)
where qIdx_{i,j} represents the transform coefficient level after compensating the impact of the multiple quantizers in DQ at coordinate (i, j) in the TB.

By observing that sign errors of large transform coefficients have a relatively higher impact on the reconstructed block, it has been found that sorting based sign selection can enhance coding efficiency by making the prediction of the signs of these large coefficients relatively easy. Nonetheless, this sorting also involves a substantial amount of computation. To achieve a better gain/complexity trade-off, in one embodiment, we propose to place the significant/non-zero coefficients with the absolute level value over a pre-defined threshold Th (e.g., the value of this threshold Th could be set to 1) at the beginning of a buffer collecting the n coefficients to do the sign prediction in a TB. If the number of coefficients n in this buffer reaches the maximum limit (n=maxNumPredSigns), the sign selection could be terminated, and these maxNumPredSigns signs are predicted; if the number of coefficients n is smaller than the maximum limit (n<maxNumPredSigns), then continue to place other significant coefficients whose absolute level value is lower than that threshold Th in this collecting buffer, the signs of the first maxNumPredSigns transform coefficients in the buffer are predicted.

In some examples, the value of this threshold Th may be pre-defined and fixed for all sequences, or be signaled in sequence parameter set (SPS), view parameter set (VPS), picture parameter set (PPS), or picture header. Alternatively, the value of this threshold Th may be dependent on the block size, e.g., width and/or height of the current block, QP, color components, block prediction mode (intra or inter coded), transform types/cores, slice types, sequence class and configuration.

### Predicted Residual Generation

The state-of-the-art predicted residual described above is generated using a simple linear prediction, which could be further improved.

For each prediction pixel P_{0,y} at the first left column of the current block, a simple linear prediction using the two reconstructed pixels to the left is performed to get its predicted residual Resi_{0,y}=(2R_{-1,y}−R_{-2,y}−P_{0,y}). The absolute difference between this predicted residual and the residual hypothesis r_{0,y} is added to the cost of the hypothesis. Generating a predicted residual that is close to the actual residual is crucial because it can significantly impact the hypothesis cost. In one embodiment, we propose to use linear prediction estimated with the least mean square (LMS) method. Suppose for a prediction pixel P_{0,y} using the two reconstructed pixels to the left to get its predicted residual, we can use the linear prediction to estimate the predicted residual as follows:

Resi_{0,y}=a₁R_{-1,y}+a₂R_{-2,y}+b−P_{0,y} (7)
where a₁ and a₂ are the scaling factors, b is the offset. For example, the values of a₁, a₂ and b are estimated using the least mean squares method, which minimizes the sum of squared differences between the actual values of the left-most R_{-1,y} and top-most R_{x,-1} reconstructed pixels and the predicted values using the two reconstructed pixels to the left (R_{-2,y} and R_{-3,y})/above (R_{x,-2} and R_{x,-3}) at the border.

In one variant of this embodiment, the linear prediction to estimate the predicted residual could be without the offset b, such as:

Resi_{0,y}=a₁R_{-1,y}+a₂R_{-2,y}−P_{0,y} (8)

Rather than using the simple linear regression with two neighboring reconstructed pixels, in another variant of this embodiment, multiple linear regression (MLR) with more than two neighboring reconstructed pixels can be used and formulated as:

$$R e s {i}_{0 , y} = {\sum }_{i = 1}^{N - 1} ( {a}_{i} {R}_{- i , y} ) + b - {P}_{0 , y} \qquad ( 9 )$$

In another variant of this embodiment, it proposes to apply the polynomial model for estimating the predicted residual, such as the conventional filter-based polynomial model used in convolutional cross-component model (CCCM).

### CABAC Context Derivation

The state-of-the-art CABAC context derivation for a sign prediction residue described above is determined by whether or not an absolute level of the dequantized coefficient in the raster order is lower/higher than 2 at the decoder parsing process. However, the first maxNumPredSigns dequantized coefficient in the raster order are not always the ones performing the sign prediction.

In one embodiment, we propose to perform the sorting based sign selection in the parsing process before decoding the signs, thus it can know what signs are predicted and, for each predicted sign, it can derive the context to use to parse the sign prediction residue based on the associated dequantized coefficient value. In one variant of this embodiment, the dependence on dequantized coefficient value for CABAC context derivation can be removed.

In another embodiment, we propose to have other derivation rules to select the CABAC context, such as based on the energy of this TB, specifically counting the number of transform coefficients whose absolute levels are greater than a pre-defined threshold (e.g., one or two) in a TB. CABAC context derivation for a predicted sign in this TB is determined by whether or not the counted number is lower or higher than another threshold (i.e., half of the number of significant transform coefficients inside this TB).

### Adaptive Maximum Number of Predicted Signs Setting

To restrict the complexity, there is a limit on the number of signs to be predicted for a TB. In ECM-8.0, the maximum number of signs (maxNumPredSigns) to be predicted is signaled to the decoder through SPS. The allowable value of maxNumPredSigns is 0 to 8, inclusive. The encoding parameter NumSignPred given to sign prediction is fixed to 8 under the CTC, which is also the value assigned to maxNumPredSigns. Additionally, to achieve a better gain/complexity trade-off, a maximum of 4 coefficient signs are allowed to be predicted for a TB using LFNST.

When the maximum number of signs (maxNumPredSigns) to be predicted is set to 8, meaning up to 2⁸ hypotheses and associated costs might need to be generated and calculated in the worst case, which involves a substantial amount of computation. Since the smaller the maximum number of predicted signs, the shorter the processing time and the smaller the computation complexity. In one embodiment, we propose to set an adaptive maximum number of predicted signs based on some conditions/parameters.

In one variant of this embodiment, the maximum number of predicted signs used for a TB can be based on the block size. Generally, if the block size, e.g., width and/or height of the current block, satisfies (e.g., is less than, is greater than, equals, etc.) a specific threshold Th (i.e., eight), a maximum of K coefficient signs would be predicted for this TB, otherwise, a maximum of μ_{K} (e.g., μ=2) coefficient signs would be predicted for this TB. For example, when maxNumPredSigns is set to 8, if the width or height of the current block is less than 8, a maximum of 4 coefficient signs would be allowed to be predicted for this TB; otherwise a maximum of 8 coefficient signs would be predicted.

In an embodiment, in terms of improving compression efficiency, the maximum number of predicted signs used for a TB increases as the block size increases. In another embodiment, if the goal is to reduce complexity, the maximum number of predicted signs used for a TB decreases as the block size increases.

In some examples, the value of this threshold Th may be pre-defined and fixed for all sequences, or be variable and signaled in SPS, VPS, PPS or picture header. Alternatively, the value of this threshold Th may be dependent on the block size, e.g., width and/or height of the current block, QP, color components, block prediction mode (intra or inter coded), transform types/cores, slice types, sequence class and configuration.

In some examples, coefficient sign prediction could also be disabled if the block sizes are very small, and/or very large.

In another variant of this embodiment, the maximum number of predicted signs used for a TB can be based on the maximum sign prediction area of this TB satisfies (e.g., is less than, is greater than, equals, etc.) a specific size. For example, a reduced maximum (i.e., 4 when maxNumPredSigns is set to 8) coefficient signs would be predicted for a TB if the maximum area for sign prediction of this TB is less than 32×32.

In another variant of this embodiment, the maximum number of predicted signs used for a TB can be based on the energy of this TB, for example, based on the number of transform coefficients whose absolute level is greater than a pre-defined threshold (i.e., one or two) in a TB. A reduced maximum of (e.g., 4 when maxNumPredSigns is set to 8) coefficient signs would be predicted for this TB depending on whether or not the counted number is lower/higher than another threshold (i.e., half of the number of significant coefficient coefficients inside this TB).

In another variant of this embodiment, the maximum number of predicted signs used for a TB can be based on the on the transform types or transform cores. For example, in the VVC and ECM, a block can use different horizontal/vertical transforms, called Multiple Transform Selection (MTS). It can also be coded using Sub-Block Transform (SBT). The maximum number of predicted signs used for a TB can be selected depending on whether the DCT-II/DCT-VIII/DST-VII/MTS/SBT is used or not for this TB.

In another variant of this embodiment, the maximum number of predicted signs used for a TB can be based on QP, color components, block prediction mode (intra or inter coded), slice types, sequence class and configuration. Those parameters/conditions could be combined to decide the maximum number of predicted signs setting.

### Others

In one embodiment, we propose to use the diagonal/zigzag order instead of the raster order in the parsing process at the decoder and in the coding process at the encoder, to improve the coding efficiency.

In another embodiment, we propose to use the internal or input bit depth instead of current SIGN_PRED_SHIFT=8 to represent the coefficient value range, to improve the coding efficiency.

In another embodiment, we propose to clip the predicted residuals or the predicted reconstruction based on the internal or input bit depth, such as, ClipBD ((2R₋₁−R₋₂−P₀), bitdepth) or ClipBD ((2R₋₁−R₋₂), bitdepth).

When luma mapping and chroma scaling (LMCS) is used, in one embodiment, we propose to perform chroma scaling on a previous reconstruction hypothesis and each template corresponding to the sign being predicted respectively first, instead of directly on the current reconstruction hypothesis. For example, the current reconstruction hypothesis in the state-of-art is obtained with Rec_{Hi}=chromaScaling|Rec_{Hi-1}−2*Tᵢ|, and in our proposed method it is obtained with Rec_{Hi}=chromaScaling|Rec_{Hi-1}|−2*chromaScaling|Tᵢ|.

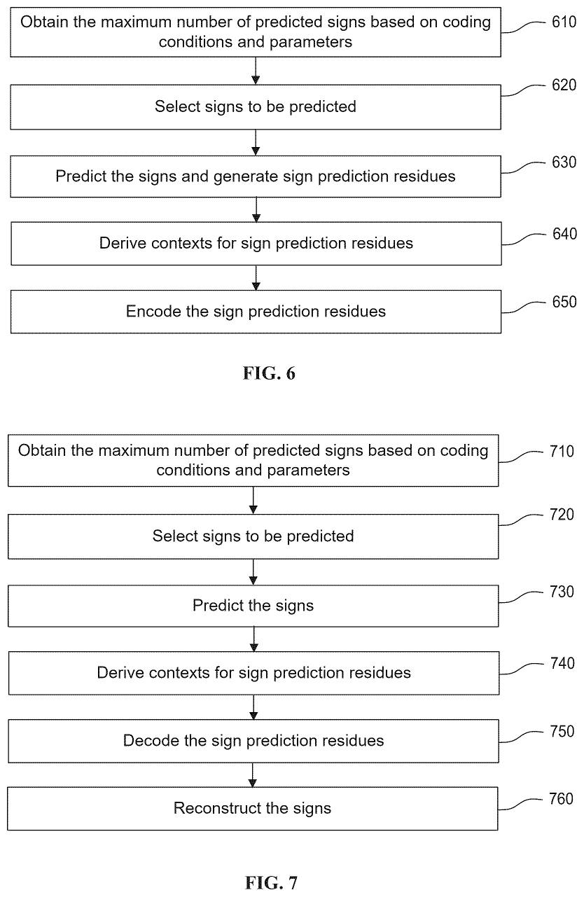

FIG. 6 illustrates a method of sign prediction at the encoder, according to an embodiment. At step 610, the maximum number of predicted signs setting is adapted based on some conditions/parameters. At step 620, signs to be predicted are selected. At step 630, the signs are predicted and sign prediction residues are generated. At step 640, the CABAC contexts are derived for sign prediction residues. At step 650, the sign prediction residues are encoded.

FIG. 7 illustrates a method of sign prediction at the decoder, according to an embodiment. At step 710, the maximum number of predicted signs setting is adapted based on some conditions/parameters. At step 720, signs to be predicted are selected. At step 730, the signs are predicted. At step 740, the CABAC contexts are derived for sign prediction residues. At step 750, the sign prediction residues are decoded. At step 760, the signs are reconstructed. Some steps for the methods illustrated in FIG. 6 and FIG. 7 are described in further details below.

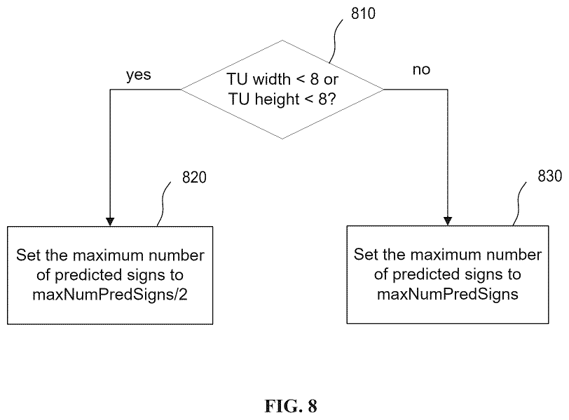

FIG. 8 illustrates a method of adapting the maximum number of predicted signs based on the block size, according to an embodiment. The width or height of the current TB is compared (810) to a specific threshold, which is 8 here. When width or height of the current TB is less than 8, half the value of maxNumPredSigns is allowed (820) for the maximum number of predicted signs for this TB; otherwise, the regular maxNumPredSigns is used (830).
1. Adaptive maximum number of predicted signs setting based on some conditions/parameters (610, 710):
   block size: if the block size, e.g., width and/or height of the current block, satisfies (e.g., is less than, is greater than, equals, etc.) a specific threshold Th (i.e., eight), reduced maximum number of predicted signs is allowed for this TB.
      specifically, width or height of the current TB is less than 8, half the value of maxNumPredSigns (i.e., 4 when maxNumPredSigns is set to 8) is allowed for the maximum number of predicted signs for this TB.
      in some examples, the value of the threshold Th may be pre-defined and fixed for all sequences, or be signaled in SPS, VPS, PPS, or picture header. Alternatively, the value of the threshold Th may be dependent on the block size, QP, color components, block prediction mode (intra or inter coded), transform types/cores, slice types, sequence class and configuration.
   maximum sign prediction area of a TB: when it satisfies (e.g., is less than, is greater than, equals, etc.) a specific size (i.e., 32×32), reduced maximum number of predicted signs is allowed for this TB.
   TB energy: counting the number of transform coefficients whose absolute level is greater than a pre-defined threshold (e.g., one or two) in a TB, reduced maximum number of predicted signs is allowed for this TB if the counted number is lower/higher than another threshold (i.e., half of the number of significant transform coefficients inside this TB).
   transform type/core: such that the maximum number of predicted signs used for a TB can be adapted to whether the DCT-II/DCT-VIII/DST-VII/MTS/SBT is used or not for this TB.
   others, such as QP, color components, block prediction mode (intra or inter coded), slice types, sequence class and configuration.
   those parameters/conditions could be used separately or combined together to decide the maximum number of predicted signs setting.
2. Select the signs to be predicted (620, 720):
   In addition to the absolute value of qIdx (qIdx is the transform coefficient level after compensating the impact of the multiple quantizers in DQ) based sorting to select the coefficients to perform sign prediction, sorting could further be done based on a weighted qIdx value.
      weight could be derived by:
         the energy impact of a transform coefficient to the samples in the L-shaped template (first left column and first top row of the current block), specifically the sum of absolute reconstructed samples in the L-shaped template corresponding to the transform coefficient, or
         the Euclidean distance between the coordinate of the transform coefficient to the top-left position of a TB, or the diagonal scanning order index of the transform coefficient in a TB.
      consider using the weighted qIdx
         only when multiple transform coefficients have the same absolute qIdx value, or
         for all transform coefficients inside the allowed sign prediction area of a TB.
   Rather than sorting, placing the significant coefficients with the absolute level value over a pre-defined threshold Th (i.e., 1) at the beginning to perform the sign prediction in a TB;
      in some examples, the value of the threshold Th may be pre-defined and fixed for all sequences, or be signaled in SPS, VPS, PPS, or picture header. Alternatively, the value of the threshold Th may be dependent on the block size, QP, color components, block prediction mode (intra or inter coded), transform types/cores, slice types, sequence class and configuration.
3. Predicted residual generation (630):
   use linear prediction estimated with the least mean square (LMS) method
      linear parameters (scaling factor(s) and offset(s)) are estimated using the least mean squares method, which minimizes the sum of squared differences between the actual values of the left-most/top-most reconstructed pixels and the predicted values using the two reconstructed pixels to its left/above.
   use linear prediction estimated with multiple linear regression (MLR), with more than two neighboring reconstructed pixels.
   use a polynomial model, such as a conventional filter-based polynomial model used in convolutional cross-component model (CCCM).
4. CABAC context derivation for a predicted sign (640, 740):
   perform the sorting-based sign selection before encoding or decoding the signs, thus it can know which signs are predicted and, for each predicted sign, it can derive the context to use to parse the sign residue based on the associated dequantized coefficient value, or
   other derivation rule: the energy of a TB, specifically counting number of coefficients whose absolute level is greater than one pre-defined threshold (i.e., one or two) in a TB. CABAC context for a predicted sign in this TB is based on whether or not the counted number is lower/higher than another threshold (i.e., half of the number of significant coefficients inside this TB).
5. Others:
   use the diagonal/zigzag order instead of the raster order in the parsing process at the decoder and in the coding process at the encoder.
   use the internal or input bit depth instead of current SIGN_PRED_SHIFT=8 to represent the coefficient value range.
   clip the predicted residuals or the predicted reconstruction based on the internal or input bit depth.
   when luma mapping and chroma scaling (LMCS) is used, perform chroma scaling on a previous reconstruction hypothesis and each template corresponding to the sign being predicted respectively first, instead of directly on the current reconstruction hypothesis.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the reconstruction modules (255, 355), of a video encoder 200 and decoder 300 as shown in FIG. 2 and FIG. 3. Moreover, the present aspects are not limited to ECM and VVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
determining a limit on the number of signs to be predicted for a block based on coding conditions and parameters;
obtaining a signal indicating whether a sign of a transform coefficient matches a predicted sign of said transform coefficient;
obtaining said predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit;
obtaining said sign for said transform coefficient, based on said predicted sign and said signal;
inverse transforming a block of transform coefficients corresponding to said block, said block of transform coefficients including said transform coefficient; and
decoding said block based on a prediction block corresponding to said block and said block of transform coefficients.

2. (canceled)

3. The method of claim 1, wherein said limit is based on a block size of said block.

4-5. (canceled)

6. The method of claim 3, wherein said limit is set to a first value and a second value, responsive to said block size being greater and smaller than a third value, respectively.

7. (canceled)

8. The method of claim 6, wherein said third value depends on at least one of a block size, a color component, a quantization parameter, a prediction mode, a transform type or core, a slice type, a sequence class and a configuration.

9. The method of claim 1, wherein said limit is based on energy of said block.

10. The method of claim 1, wherein said limit is based on at least one of a transform type or transform core for said block, a color component, a prediction mode, a transform type or core, a slice type, a sequence class and a configuration.

11. An apparatus, comprising at least one memory and one or more processors, wherein said one or more processors are configured to:
determine a limit on the number of signs to be predicted for a block based on coding conditions and parameters;
obtain a signal indicating whether a sign of a transform coefficient matches a predicted sign of said transform coefficient;
obtain said predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit;
obtain said sign for said transform coefficient, based on said predicted sign and said signal;
inverse transform a block of transform coefficients corresponding to said block, said block of transform coefficients including said transform coefficient; and
decode said block based on a prediction block corresponding to said block and said block of transform coefficients.

12. (canceled)

13. The apparatus of claim 11, wherein said limit is based on a block size of said block.

14-18. (canceled)

19. The apparatus of claim 11, wherein said limit is based on energy of said block.

20. The apparatus of claim 11, wherein said limit is based on at least one of a transform type or transform core for said block, a color component, a prediction mode, a transform type or core, a slice type, a sequence class and a configuration.

21-22. (canceled)

23. A method of video encoding, comprising:
determining a limit on the number of signs to be predicted for a block based on coding conditions and parameters;
obtaining a sign of a transform coefficient;
obtaining a predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit;
obtaining a signal to indicate whether said predicted sign matches said sign of said transform coefficient; and
encoding said signal.

24. The method of claim 23, wherein said limit is based on a block size of said block.

25. The method of claim 23, wherein said limit is set to a first value and a second value, responsive to said block size being greater and smaller than a third value, respectively.

26. The method of claim 25, wherein said third value depends on at least one of a block size, a color component, a quantization parameter, a prediction mode, a transform type or core, a slice type, a sequence class and a configuration.

27. The method of claim 23, wherein said limit is based on energy of said block.

28. The method of claim 23, wherein said limit is based on at least one of a transform type or transform core for said block, a color component, a prediction mode, a transform type or core, a slice type, a sequence class and a configuration.

29. An apparatus, comprising at least one memory and one or more processors, wherein said one or more processors are configured to:
determine a limit on the number of signs to be predicted for a block based on coding conditions and parameters;
obtain a sign of a transform coefficient;
obtain a predicted sign for said transform coefficient, responsive to said transform coefficient belonging to a subset of transform coefficients of said block, wherein a sign for each transform coefficient in said subset of transform coefficients is to be predicted, and wherein the number of transform coefficients in said subset of transform coefficients is within said limit;
obtain a signal to indicate whether said predicted sign matches said sign of said transform coefficient; and
encode said signal.

30. The apparatus of claim 29, wherein said limit is based on a block size of said block.

31. The apparatus of claim 29, wherein said limit is based on energy of said block.

32. The apparatus of claim 29, wherein said limit is based on at least one of a transform type or transform core for said block, a color component, a prediction mode, a transform type or core, a slice type, a sequence class and a configuration.
